(19) United States
(12) Patent Application Publication
(10) Pub. No.: US 2014/0274552 A1
(43) Pub. Date: Sep. 18, 2014

(54) CVT VARIATOR BALL AND METHOD OF CONSTRUCTION THEREOF

(71) Applicant: DANA LIMITED, Maumee, OH (US)

(72) Inventors: Michael Patrick Frink, Austin, TX (US); Stephen W. Schinzing, Austin, CA (US)

(73) Assignee: DANA LIMITED, Maumee, OH (US)

(21) Appl. No.: 14/210,130

(22) Filed: Mar. 13, 2014

Related U.S. Application Data
(60) Provisional application No. 61/786,034, filed on Mar. 14, 2013.

(51) Int. Cl. F16H 55/32

(52) U.S. Cl. CPC F16H 55/32
USPC 476/36; 29/428

(57) ABSTRACT

Hollow variator balls and methods of manufacturing hollow variator balls are disclosed. Certain methods include press forming of a cylindrical body into hollow sphere using counter rotating spherical dies, hot roll forming and skew rolling, and means of rotational support are coupled to the hollow spheres such as axles, half axles, or sleeves.

### CROSS-REFERENCES TO RELATED APPLICATIONS

The present application claims priority to U.S. Provisional Patent Application No. 61/786,034, filed Mar. 14, 2013 which application is incorporated herein by reference.

### BACKGROUND OF THE INVENTION

A vehicle having a driveline including a tilting ball variator allows an operator of the vehicle or a control system of the vehicle to vary a drive ratio in a stepless manner A variator is an element of a Continuously Variable Transmission (CVT) or an Infinitely Variable Transmission (IVT). Transmissions that use a variator can decrease the engine's gear ratio as engine speed increases. This keeps the engine within its optimal efficiency while gaining ground speed, or trading speed for hill climbing. Efficiency in this case can be fuel efficiency, decreasing fuel consumption and emissions output, or power efficiency, allowing the engine to produce its maximum power over a wide range of speeds. That is, the variator keeps the engine turning at constant RPMs over a wide range of vehicle speeds.

### SUMMARY OF THE INVENTION

A tilting ball variator includes a first drive ring, a second drive ring, and a plurality of variator balls disposed between the first drive ring and the second drive ring. The plurality of variator balls is simultaneously tilted, which adjusts an axis angle of each of the variator balls, for example, by moving a carrier, the plurality of variator balls are rotatably disposed on. The plurality of variator balls are in driving engagement with the first drive ring and the second drive ring through one of a boundary layer type friction and an elastohydrodynamic film. A gear ratio between the carrier (if driven), the first drive ring, and the second drive ring may be adjusted by changing the axis angle of the plurality of variator balls.

The conventional variator ball is a solid metal sphere that includes a perforation therethrough, which passes through a center of the variator ball. The axle and a needle bearing are inserted within the perforation to permit the variator ball to rotate thereabout, and the axle is secured at each end to the carrier. As variator balls grow larger to accommodate larger CVT/IVT's loads, the weight and moment of inertia negatively affect the efficiency of the CVT. The variator balls are in driving engagement with the first drive ring and the second drive ring through one of a boundary layer type friction and an elastohydrodynamic film where the increased moment of inertia and weight of large variator balls decrease the effectiveness of the elastohydrodynamic boundary layer friction coupling between the variator balls and drive rings. Loss of effective frictional coupling leads to decreases in efficiency and performance of the overall CVT. As the diameter of variator balls begins to exceed 3 inches, weight reduction measures may become necessary to preserve performance. Additionally, the elastohydrodynamic boundary layer friction coupling requires a high degree of geometric accuracy. Consequently precise forming of each of the variator balls is required for the tilting ball variator to operate. Operation of the variator balls requires an extremely high degree of rotational symmetry. The axles or sleeves supporting the variator balls must be axially well aligned with the center of the variator ball.

Provided herein is a method of manufacturing a hollow variator ball comprising a hollow main spherical portion and a rotational support structure having an axis well aligned with a center of the variator ball. In some embodiments, the hollow variator ball is a seamless hollow variator ball.

In some embodiments, creating the hollow spherical main portion of the variator comprises positioning a deformable cylindrical tubular member of predetermined length and diameter and wall thickness between two separated opposing counter-rotating hemispherical dies rotatable on a common axis coincident with the axis of the cylinder. In some embodiments the method further comprises press forming the deformable cylinder into a hollow sphere having two circular apertures on opposite sides of the sphere by moving the two hemispherical dies towards each other. Some embodiments further comprise coupling the rotational support structure to at least one of the circular apertures such that the axis of rotation of the support structure passes through the center of the hollow spherical main portion. In some embodiments the rotational support structure may comprise: a solid cylindrical axle, a pair of half axles, or a hollow cylindrical sleeve. The rotational support structure may also comprise needle bearings engaged with the circular apertures.

In some embodiments, coupling the rotational support structure comprises creating an interference fit. Creating an interference fit may comprise press-fitting or shrink fitting. Special surface conditions may facilitate a fully stable shrink fit.

In some embodiments, the two dies each have an aperture located about their axis of rotation sized to allow an axle to pass therethrough such that the axis of rotation of the axle coincides with the axis of rotation of the deformable cylinder and such that the dies rotate about the axle. In these and other embodiments coupling may comprise positioning the axle inside the deformable cylinder as it is being press-formed into the hollow sphere such that the axle is press fitted into the circular apertures as they are forming

In some embodiments, the hollow cylindrical sleeve is sized to seal the interior of the hollow main spherical portion from the exterior of the hollow main spherical portion. Additionally, needle bearings may be installed inside the hollow cylindrical sleeve such that the variator ball can spin about a central axis.

In some embodiments of the method described herein, the two dies each have an aperture located about their axis of rotation sized to allow the axle to pass therethrough such that the axis of rotation of the axle coincides with the axis of rotation of the deformable cylinder and such that the dies rotate about the axle. Coupling the rotational support structure may comprise positioning the axle inside the deformable cylinder as it is being press-formed into the hollow sphere such that the axle is press-fitted into the circular apertures as they are forming.

In some embodiments of the method described herein, the two dies each have an aperture located about their axis of rotation sized to allow the pair of half axles to pass therethrough such that the axis of rotation of the pair of half axles coincides with the axis of rotation of the deformable cylinder and such that the dies rotate about the pair of half axles. Coupling the rotational support structure may comprise positioning the pair of half axles inside the deformable cylinder as it is being press-formed into the hollow sphere such that the pair of half axles is press-fitted into the circular apertures as they are forming

In some embodiments of the methods described herein, the two dies each have an aperture located about their axis of rotation sized to allow the hollow cylindrical sleeve to pass therethrough such that the axis of rotation of the hollow cylindrical sleeve coincides with the axis of rotation of the deformable cylinder and such that the dies rotate about the hollow cylindrical sleeve. Coupling the rotational support structure may comprise positioning the hollow cylindrical sleeve inside the deformable cylinder as it is being press-formed into the hollow sphere such that the hollow cylindrical sleeve is press-fitted into the circular apertures as they are forming.

In various embodiments of the methods described herein, the spherical accuracy of the interior of the hollow spherical main portion may be improved by pressurizing a spherical bladder disposed in the interior of the hollow spherical main portion while simultaneously constraining the hollow spherical main portion inside a sphere shaped die apparatus.

In some embodiments improving the spherical accuracy of the interior of the hollow spherical main portion comprises detonating an explosive inside the hollow spherical main portion while simultaneously constraining the hollow spherical main portion inside a sphere shaped die apparatus.

In some embodiments the hollow spherical main portion comprises a metal. In some embodiments the hollow spherical main portion comprises steel.

Some embodiments of the invention detail a method of producing hollow ceramic variator balls. A spherical pressurized bladder having two fluid lumina diametrically opposed to each other is suspended in a ceramic precursor inside encased between two hemispherical dies, the dies having channels for the fluid lumina. The ceramic precursor is reacted to form a hollow ceramic spherical ball having two apertures diametrically opposed to each other.

In some embodiments of the invention herein the diameter of the hollow spherical main portion is between 2 and 6 inches. In other embodiments the diameter of the hollow spherical main portion is between 6 and 18 inches. In yet other embodiments the diameter of the hollow spherical main portion is between 18 and 24 inches.

Provide herein is a method for forming multiple planets simultaneously comprising inserting an inner sleeve or bar support into an elongate cylindrical piece of tube stock. The tube stock is then selectively heated and roll formed into multiple spheroid objects connected by a central cylindrical lumen. The roll forming operation is repeated until the tube stock has been formed into multiple rough spheres joined by the central cylindrical lumen. In some embodiments, the spherical accuracy is improved by turning the multiple rough spheres on a lathe. Cutting the common lumen separates the spheres thereby producing multiple planets, each planet having diametrically opposed apertures. The multiple planets are produced by cutting the common lumen to separate the spheres. In some embodiments, the multiple rough spheres are coupled to a rotational support structure via the diametrically opposed apertures made when cutting the common lumen. The multiple planets may further be coupled to a rotational support structure such as an axle, pair of half axles, or hollow cylindrical sleeve.

Provided herein is a variable transmission comprising a variator ball formed by any of the methods of creating one or more variator balls described herein or obvious to one of skill in the art upon reading the disclosure herein.

Provided herein is a variator ball formed by any of the methods described herein or obvious to one of skill in the art upon reading the disclosure herein.

Provided herein is a vehicle driveline comprising a variable transmission comprising a variator ball formed by any of the methods of creating one or more variator balls described herein or obvious to one of skill in the art upon reading the disclosure herein.

Provided herein is a vehicle driveline comprising an engine, a vehicle output, and a variable transmission comprising a variator ball formed by any of the methods described herein or obvious to one of skill in the art upon reading the disclosure herein.

Provided herein is a vehicle comprising the variable transmission comprising one or more variator balls formed by any of the methods of creating one or more variator balls described herein or obvious to one of skill in the art upon reading the disclosure herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-1B depict press-forming a deformable cylindrical tubular member.

FIGS. 2A-2B depict press-forming a deformable cylindrical tubular member wherein lumina are present in the die and a rotational support structure is coupled to the hollow sphere as it is formed.

FIGS. 3A-3D depict cross sections of the variator balls with different rotational support structures.

FIGS. 4A-4B show a pressurized fluid bladder used to improve the internal spherical accuracy of a hollow sphere or aid in the assistance of a ceramic sphere.

FIGS. 5A-5B depict the use of explosive detonation to improve the internal spherical accuracy of a hollow sphere.

FIGS. 6A-6E depict a method of forming multiple planets in a batch.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Provided herein is a method of manufacturing a hollow variator ball comprising a hollow main spherical portion and a rotational support structure having an axis well aligned with a center of the variator ball.

In some embodiments, the variator (CVP) of a variable transmission itself works with a traction fluid. In some embodiments, the lubricant between the ball and the conical rings acts as a solid at high pressure, transferring the power from the first ring assembly, through the variator balls, to the second ring assembly. By tilting the variator balls' axles, the ratio can be changed between input and output. When the axle of each of the variator balls is horizontal, the ratio is one. When the axles are tilted, the distance between the axles and the contact point changes, modifying the overall ratio. In some embodiments, all the variator balls' axles are tilted at the same time with a mechanism included in the cage.

Provided herein is a method of manufacturing a variator ball comprising a hollow spherical main portion and a rotational support structure having an axis of rotation well aligned with the center of the hollow spherical main portion, the method comprising: creating the hollow spherical main portion of the variator ball by positioning a deformable cylindrical tubular member of predetermined length, diameter and wall thickness between two separated opposing counter-rotating hemispherical dies rotatable on a common axis coincident with the axis of the cylinder, and press forming the deformable cylinder into a hollow sphere having two circular apertures on opposite sides of the sphere by moving the two hemispherical dies towards each other; and coupling the rotational support structure to at least one of the circular apertures such that the axis of rotation of the support structure passes through the center of the hollow spherical main portion, wherein the rotational support structure comprises a solid cylindrical axle passing through the circular apertures.

In some embodiments, creating the hollow spherical main portion of the variator comprises positioning a deformable cylindrical tubular member of predetermined length and diameter and wall thickness between two separated opposing counter-rotating hemispherical dies rotatable on a common axis coincident with the axis of the cylinder. In some embodiments the method further comprises press forming the deformable cylinder into a hollow sphere having two circular apertures on opposite sides of the sphere by moving the two hemispherical dies towards each other. Some embodiments further comprise coupling the rotational support structure to at least one of the circular apertures such that the axis of rotation of the support structure passes through the center of the hollow spherical main portion. In some embodiments the rotational support structure may comprises: a solid cylindrical axle, a pair of half axles, or a hollow cylindrical sleeve. The rotational support structure may also comprise needle bearings engaged with the circular apertures.

In some embodiments, coupling the rotational support structure comprises creating an interference fit. In some embodiments, creating an interference fit may comprise press-fitting or shrink fitting. In some embodiments, special surface conditions may facilitate a fully stable shrink fit. In some embodiments, rotational support structures (axles) are welded into place following formation and semi-finishing of the planet. Laser welding is one preferred method. Welding in an inert gas field and pre-heating the material may also be necessary due to material composition. Alternately, the spinning press-forming operation results in a spin-welding or fusion welding process that couples the support structures to the sphere.

In some embodiments, the two dies each have an aperture located about their axis of rotation sized to allow an axle to pass therethrough such that the axis of rotation of the axle coincides with the axis of rotation of the deformable cylinder and such that the dies rotate about the axle. In these and other embodiments coupling may comprise positioning the axle inside the deformable cylinder as it is being press-formed into the hollow sphere such that the axle is press fitted into the circular apertures as they are forming

In some embodiments, the hollow cylindrical sleeve is sized to seal the interior of the hollow main spherical portion from the exterior of the hollow main spherical portion. Additionally, in some embodiments needle bearings are installed inside the hollow cylindrical sleeve such that the variator ball can spin about a central axis.

In some embodiments of the method described herein, the two dies each have an aperture located about their axis of rotation sized to allow the axle to pass therethrough such that the axis of rotation of the axle coincides with the axis of rotation of the deformable cylinder and such that the dies rotate about the axle. Coupling the rotational support structure may comprise positioning the axle inside the deformable cylinder as it is being press-formed into the hollow sphere such that the axle is press-fitted into the circular apertures as they are forming.

In some embodiments of the method described herein, the two dies each have an aperture located about their axis of rotation sized to allow the pair of half axles to pass therethrough such that the axis of rotation of the pair of half axles coincides with the axis of rotation of the deformable cylinder and such that the dies rotate about the pair of half axles. Coupling the rotational support structure may comprise positioning the pair of half axles inside the deformable cylinder as it is being press-formed into the hollow sphere such that the pair of half axles is press-fitted into the circular apertures as they are forming.

In some embodiments of the methods described herein, the two dies each have an aperture located about their axis of rotation sized to allow the hollow cylindrical sleeve to pass therethrough such that the axis of rotation of the hollow cylindrical sleeve coincides with the axis of rotation of the deformable cylinder and such that the dies rotate about the hollow cylindrical sleeve. Coupling the rotational support structure may comprise positioning the hollow cylindrical sleeve inside the deformable cylinder as it is being press-formed into the hollow sphere such that the hollow cylindrical sleeve is press-fitted into the circular apertures as they are forming.

In various embodiments of the methods described herein, the spherical accuracy of the interior of the hollow spherical main portion may be improved by pressurizing a spherical bladder disposed in the interior of the hollow spherical main portion while simultaneously constraining the hollow spherical main portion inside a sphere shaped die apparatus.

In some embodiments, improving the spherical accuracy of the interior of the hollow spherical main portion comprises detonating an explosive inside the hollow spherical main portion while simultaneously constraining the hollow spherical main portion inside a sphere shaped die apparatus. In some embodiments, multiple detonations of an explosive may be required to obtain the desired shape of the hollow sphere.

Provide herein is a method for forming multiple planets simultaneously comprising inserting an inner sleeve or bar support into an elongate cylindrical piece of tube stock. The tube stock is then selectively heated and roll formed into multiple spheroid objects connected by a central cylindrical lumen. The roll forming operation is repeated until the tube stock has been formed into multiple rough spheres joined by the central cylindrical lumen. In some embodiments, the spherical accuracy is improved by turning the multiple rough spheres on a lathe. Cutting the common lumen separates the spheres thereby producing multiple planets, each planet having diametrically opposed apertures. The multiple planets are produced by cutting the common lumen to separate the spheres. In some embodiments, the multiple rough spheres are coupled to a rotational support structure via the diametrically opposed apertures made when cutting the common lumen. The multiple planets may further be coupled to a rotational support structure such as an axle, pair of half axles, or hollow cylindrical sleeve.

In some embodiments, the hollow spherical main portion comprises a metal. In some embodiments, the hollow spherical main portion comprises steel. In still other embodiments and manufacturing methods described herein, the hollow spherical main portion comprises a ceramic.

Some embodiments of the invention detail a method of producing hollow ceramic variator balls. A spherical pressurized bladder having two fluid lumina diametrically opposed to each other is suspended in a ceramic precursor inside encased between two hemispherical dies, the dies having channels for the fluid lumina. The ceramic precursor is reacted to form a hollow ceramic spherical ball having two apertures diametrically opposed to each other.

As defined herein a lumen (or lumina, pl.) is the inner bore diameter of a tubular structure, or central cavity of a hollow structure.

In some embodiments of the invention herein the diameter of the hollow spherical main portion is between 2 and 6 inches. In other embodiments the diameter of the hollow spherical main portion is between 6 and 18 inches. In yet other embodiments the diameter of the hollow spherical main portion is between 18 and 24 inches.

Some embodiments provide methods for forming multiple planets comprising inserting an inner sleeve or bar support into an elongated cylindrical piece of tube stock. The tube stock is then selectively heated and roll formed into multiple spheroid objects connected by a central cylindrical lumen. The roll forming operation is repeated until the tube stock has been formed into multiple rough spheres joined by the central cylindrical lumen. In some embodiments, the spherical accuracy is improved by turning the multiple rough spheres on a lathe. Cutting the common lumen separates the spheres thereby producing multiple planets, each planet having diametrically opposed apertures. The multiple planets are produced by cutting the common lumen to separate the spheres. In some embodiments, the multiple planets have a ground finish. In some embodiments the multiple planets having a ground finish by using standard ball finishing techniques. In some embodiments, the multiple rough spheres are coupled to a rotational support structure via the diametrically opposed apertures made when cutting the common lumen. The multiple planets may further be coupled to a rotational support structure such as an axle, pair of half axles, or hollow cylindrical sleeve.

FIGS. 1A-1B depict the press forming of a deformable cylindrical tubular member 1 into a hollow sphere 3 having two circular apertures 9 by two opposing counter-rotating die 2a, 2b.

As one skilled in the art would understand after reading this disclosure, the length of the deformable cylindrical tubular member 1 can be predetermined and the size of the apertures 9 can be closely controlled.

FIGS. 2A-2B depict the press forming of a deformable cylindrical tubular member 1 into a hollow sphere 3 wherein the die have lumina 6 that allow rotational support structure 4 to be coupled to sphere 3 during the forming operation.

The spinning press-forming operation results in a spin-welding or fusion welding process that couples the support structures to the sphere.

FIGS. 3A-3D show cross-sections of various hollow spherical main portions having different rotational support structures. FIG. 3A shows a solid axle 11, FIG. 3B shows a pair of half axles 8, FIG. 3C shows a hollow cylindrical sleeve 12, and FIG. 3D shows a dual inner formed lumen 13.

FIGS. 3A and 3C illustrate rotational support structures that are routinely inserted in secondary operations after the sphere has been formed and had at least a minimum number of finishing operations performed thereon. FIGS. 3B and 3D illustrate rotational support structures which can be inserted during the spinning press-forming operation resulting in a spin-welding or fusion welding process or manually inserted in secondary operations after the sphere has been formed.

In some embodiments, rotational support structures (axles) are welded into place following formation and semi-finishing of the planet. Laser welding is one preferred method. Welding in an inert gas field may also be necessary due to material composition.

FIG. 4A-4B depicts using fluid pressure to increase spherical accuracy inside a hollow sphere. Upper die 50 and lower die 51 are seen confining hollow sphere 3 while pressure 55 builds inside bladder 30. Also shown in FIG. 4B is ceramic precursor 25 which may be used in the manufacture of ceramic variator balls in much the same fashion.

As one skilled in the art will recognize after reading this disclosure, the ceramic may be “pre-machined” in the green state to allow for the placement of an axle prior to sintering. Alternatively, an axle can be brazed to the ceramic after sintering.

FIG. 5A-5B depicts using a detonation 53 from an explosive located within a deformable cylindrical tube 1 confined by upper die 50 and lower die 51 in order to increase internal spherical accuracy of hollow sphere 3. As stated previously, multiple detonations of explosive charges may be required to obtain the desired shape.

FIGS. 6A-6E show a method of creating multiple planets. Inner sleeve or bar support 41 is inserted into tube stock 40, as illustrated in FIG. 6B. The step 42 of selective heating and rolling is used to form rough spheres 45, as illustrated in FIG. 6C. This is repeated, and, in step 43, a lathe, grinder, or comparable finishing process is used to increase spherical accuracy of spheres 46, as illustrated in FIG. 6D. The step 44 of cutting of the common lumen material 47 produces multiple hollow spheres (planets) 3, as illustrated in FIG. 6E.

As one skilled in the art would understand after reading this disclosure, the step 42 of selective heating and rolling may be performed once or several times, depending on the process and or equipment utilized, in order to produce a near-net finished sphere (planet) that is ready for secondary finishing (step 43) and separation (step 44). Lumen 47 can be removed by secondary machining operations (step 44); or if no inner sleeve is used, hollow sleeves can have external lumen similar to FIG. 3B.

Provided herein is a variable transmission comprising a variator ball formed by any of the methods of creating one or more variator balls described herein or obvious to one of skill in the art upon reading the disclosure herein.

Provided herein is a variator ball formed by any of the methods described herein or obvious to one of skill in the art upon reading the disclosure herein.

Provided herein is a vehicle driveline comprising a variable transmission comprising a variator ball formed by any of the methods of creating one or more variator balls described herein or obvious to one of skill in the art upon reading the disclosure herein.

Provided herein is a vehicle driveline comprising an engine, a vehicle output, and a variable transmission comprising a variator ball formed by any of the methods described herein or obvious to one of skill in the art upon reading the disclosure herein.

Provided herein is a vehicle comprising the variable transmission comprising one or more variator balls formed by any of the methods of creating one or more variator balls described herein or obvious to one of skill in the art upon reading the disclosure herein.

Embodiments of the variable transmission described herein or that would be obvious to one of skill in the art upon reading the disclosure herein, are contemplated for use in a variety of vehicle drivelines. For non-limiting example, the variable transmissions disclosed herein may be used in bicycles, mopeds, scooters, motorcycles, automobiles, electric automobiles, trucks, sport utility vehicles (SUV's), lawn mowers, tractors, harvesters, agricultural machinery, all-terrain vehicles (ATV's), jet skis, personal watercraft vehicles, airplanes, trains, helicopters, buses, forklifts, golf carts, motorships, steam powered ships, submarines, space craft, or other vehicles that employ a transmission.

1. A method of manufacturing a variator ball comprising a hollow spherical main portion and a rotational support structure having an axis of rotation well aligned with the center of the hollow spherical main portion, the method comprising:
creating the hollow spherical main portion of the variator ball by
positioning a deformable cylindrical tubular member of predetermined length, diameter and wall thickness between two separated opposing counter-rotating hemispherical dies rotatable on a common axis coincident with the axis of the cylinder, and
press forming the deformable cylinder into a hollow sphere having two circular apertures on opposite sides of the sphere by moving the two hemispherical dies towards each other; and
coupling the rotational support structure to at least one of the circular apertures such that the axis of rotation of the support structure passes through the center of the hollow spherical main portion,
wherein the rotational support structure comprises a solid cylindrical axle passing through the two circular apertures.

2. A method of manufacturing a variator ball comprising a hollow spherical main portion and a rotational support structure having an axis of rotation well aligned with the center of the hollow spherical main portion, the method comprising:
creating the hollow spherical main portion of the variator ball by
positioning a deformable cylindrical tubular member of predetermined length diameter and wall thickness between two separated opposing counter-rotating hemispherical dies rotatable on a common axis coincident with the axis of the cylinder, and
press forming the deformable cylinder into a hollow sphere having two circular apertures on opposite sides of the sphere by moving the two hemispherical dies towards each other; and
coupling the rotational support structure to at least one of the circular apertures such that the axis of rotation of the support structure passes through the center of the hollow spherical main portion,
wherein the rotational support structure comprises a pair of half axles, each coupled to one of the circular apertures.

3. A method of manufacturing a variator ball comprising a hollow spherical main portion and a rotational support structure having an axis of rotation well aligned with the center of the hollow spherical main portion, the method comprising:
creating the hollow spherical main portion of the variator ball by
positioning a deformable cylindrical tubular member of predetermined length diameter and wall thickness between two separated opposing counter-rotating hemispherical dies rotatable on a common axis coincident with the axis of the cylinder,
press forming the deformable cylinder into a hollow sphere having two circular apertures on opposite sides of the sphere by moving the two hemispherical dies towards each other; and
coupling the rotational support structure to at least one of the circular apertures such that the axis of rotation of the support structure passes through the center of the hollow spherical main portion,
wherein the rotational support structure comprises a hollow cylindrical sleeve that passes through the two circular apertures.

4. (canceled)

5. The method of claim 3, wherein the hollow cylindrical sleeve is sized to seal the interior of the hollow main spherical portion from the exterior of the hollow main spherical portion.

6. The method of claim 3, further comprises installing needle bearings inside the hollow cylindrical sleeve such that the variator ball can spin about a central axis.

7. The method of claim 1, wherein coupling the rotational support structure comprises creating an interference fit.

8. The method of claim 7, wherein creating an interference fit comprises press-fitting or shrink fitting

9. The method of claim 1, wherein the two separated opposing counter-rotating hemispherical dies each have an aperture located about their axis of rotation sized to allow the axle to pass therethrough such that the axis of rotation of the axle coincides with the axis of rotation of the deformable cylinder and such that the dies rotate about the axle; and wherein coupling comprises positioning the axle inside the deformable cylinder as it is being press-formed into the hollow sphere such that the axle is press-fitted into the circular apertures as they are forming.

10. The method of claim 3, wherein the two dies each have an aperture located about their axis of rotation sized to allow the hollow cylindrical sleeve to pass therethrough such that the axis of rotation of the hollow cylindrical sleeve coincides with the axis of rotation of the deformable cylinder and such that the dies rotate about the hollow cylindrical sleeve; and
wherein coupling comprises positioning the hollow cylindrical sleeve inside the deformable cylinder as it is being press-formed into the hollow sphere such that the hollow cylindrical sleeve are press-fitted into apertures as they are forming.

11. The method of claim 1, further comprising improving the spherical accuracy of the interior of the hollow spherical main portion by pressurizing a spherical bladder disposed inside the hollow spherical main portion while simultaneously constraining the hollow spherical main portion inside a sphere shaped die apparatus.

12. The method of claim 2, further comprising improving the spherical accuracy of the interior of the hollow spherical main portion by pressurizing a spherical bladder disposed inside the hollow spherical main portion while simultaneously constraining the hollow spherical main portion inside a sphere shaped die apparatus.

13. The method of claim 3, further comprising improving the spherical accuracy of the interior of the hollow spherical main portion by pressurizing a spherical bladder disposed inside the hollow spherical main portion while simultaneously constraining the hollow spherical main portion inside a sphere shaped die apparatus.

14. (canceled)

15. The method of claim 1, further comprising improving the spherical accuracy of the interior of the hollow spherical main portion by detonating at least one explosive inside the hollow spherical main portion while simultaneously constraining the hollow spherical main portion inside a sphere shaped die apparatus.

16. The method of claim 2, further comprising improving the spherical accuracy of the interior of the hollow spherical main portion by detonating at least one explosive inside the hollow spherical main portion while simultaneously constraining the hollow spherical main portion inside a sphere shaped die apparatus.

17. The method of claim 3, further comprising improving the spherical accuracy of the interior of the hollow spherical main portion by detonating at least one explosive inside the hollow spherical main portion while simultaneously constraining the hollow spherical main portion inside a sphere shaped die apparatus.

18-34. (canceled)

35. A variator ball formed by the method of claim 1.

36. A variable transmission comprising the variator of claim 35.

37. A variator ball formed by the method of claim 2.

38. A variable transmission comprising the variator of claim 37.

39. A variator ball formed by the method of claim 3.

40. A variable transmission comprising the variator of claim 39.
